(19) United States
(12) Patent Application Publication
(10) Pub. No.: US 2007/0006220 A1
(43) Pub. Date: Jan. 4, 2007

(54) Computer system, system software installation method, and software installation method of portable computer

(75) Inventor: Jae Woong Han, Seoul (KR)

Correspondence Address: FLESHNER & KIM, LLP, P.O. BOX 221200, CHANTILLY, VA, 20153, US

(73) Assignee: LG ELECTRONICS INC.

(21) Appl. No.: 11/237,850

(22) Filed: Sep. 29, 2005

(30) Foreign Application Priority Data
May 20, 2005 (KR) 10-2005-42322

(51) Int. Cl. G06F 9/445

(52) U.S. Cl. 717/174

(57) ABSTRACT

Embodiments of a computer system, and a software installation method thereof are described. An embodiment of a computer system can include a system for installing an O/S (Operating/System) and a part of system software; a storage unit for storing a plurality of system software, which can be installed depending on various O/Ses or devices; and a controlling unit for selectively installing system software, which is required for the system, among the stored plurality of system software.

### BACKGROUND OF THE INVENTION

1. Field of the Invention

The present invention relates to a computer system, and a software installation method of a portable computer.

2. Background of the Related Art

FIG. 1 illustrates a related-art portable computer. In general, a portable computer is advantageous because it has a smaller size and less weight than a desktop computer.

The related-art portable computer 10 includes a main body 11 and a display unit 12. The main body 11 and the display unit 12 are engaged with each other such that the display unit 12 can be folded or unfolded to or from the main body 11 by a hinge unit 13.

A main board, a hard disk, and various parts are installed inside of the main body 11. A keyboard 14 is an input unit and is provided at a top of the main body 11. The keyboard 14 has a plurality of keys arranged in a plurality of rows and columns.

The display unit 12 includes a display module 16. The display module 16 usually employs a liquid crystal panel. A signal communicates between the main body 11 and the display unit 12 through a signal connection wire that is disposed inside of the hinge unit 13.

FIG. 2 illustrates a related-art method for installing an Operating/System (O/S) and system software in a portable computer. In the portable computer, software such as an Operating System (O/S) and various drivers or utilities, are pre-loaded on a system in its partial manufacture process.

As shown in FIG. 2, after a hardware configuration and a software configuration are prepared, the O/S is installed in the computer (block 200). Next, a device driver is installed (block 210).

Further, a utility is installed (block 220). Finally, the O/S is set based on the installed O/S and software (block 230).

After the O/S and the software are completely installed through the above process, the portable computer is tested and sold to a consumer. Accordingly, the consumer can use the computer without installing separate software.

Recently, because of the diversity of a computer performance, a manufacture company, the O/S, the software, and a language environment, many kinds of software should be installed in the computer. Therefore, a pre-load image is also abruptly increased in number.

In general, pre-loading is performed using a server-based system. The server holds all types of pre-load images (for example, an O/S language, an O/S version, and a manufacture company and a model of various devices).

As described above, the related art computer system and software installation method of the computer system have various disadvantages. For example, there is a drawback in that when the pre-load image is increased in number, costs to manage the server rapidly increase. Further, there is a drawback in that much human power, effort and time are required to develop the pre-load image. In addition, it is required to develop more pre-load images in a shorter time because of a shorter life cycle of a computer model. Also, there is a drawback in that a manufacture time of the computer can be equal to a time taken to pre-load the pre-load image through the server. Accordingly, costs for a portable computer increase.

The above references are incorporated by reference herein where appropriate for appropriate teachings of additional or alternative details, features and/or technical background.

### SUMMARY OF THE INVENTION

An object of the invention is to solve at least the above problems and/or disadvantages or to provide at least the advantages described hereinafter.

Another object of the present invention is to provide a computer system and software installation method that can solve at least the problems and disadvantages of the background art or provide at least the advantages described hereinafter.

Another object of the present invention is to provide a software installation method of a portable computer that can install a pre-load image so that the pre-load image can be developed with less time or cost.

Another object of the present invention is to provide a software installation method and apparatus of a portable computer for reducing costs for a server for storing a pre-load image.

Another object of the present invention is to provide a portable computer and method that can change or store a pre-load image for effectively installing a pre-load image.

To achieve these and other advantages in a whole or in part and in accordance with the purpose of the present invention, as embodied and broadly described, there is provided a computer system that includes a storage unit configured to store a plurality of system software, which can be installed depending on an installation script, wherein the installation script is deleted after installation is complete and a controller configured to selectively install system software that is required for the system, among the stored plurality of system software according to the installation script.

To further achieve these and other advantages in a whole or in part and in accordance with the purpose of the present invention, as embodied and broadly described, there is provided a system software installation method that includes identifying a configuration of a computer system, comparing the identified configuration with at least one installation script file corresponding to system software and selectively installing a plurality of system software stored in a storage unit responsive to the comparison and deleting said at least one installation script file.

To further achieve these and other advantages in a whole or in part and in accordance with the purpose of the present invention, as embodied and broadly described, there is provided software installation method of a portable computer, the method includes inserting a storage medium for recording an installation script file, retrieving an O/S (Operating/System) or a device stored in a computer system, comparing the installation script file with information of the retrieved O/S or device and selectively installing system software depending on the comparison result, wherein the installation script file is removed after the installation of the system software.

To further achieve these and other advantages in a whole or in part and in accordance with the purpose of the present invention, as embodied and broadly described, there is provided a computer system that includes unit for installing system software according to an installation script and unit for storing a plurality of system software that can be installed depending on the installation script, wherein the installation script is deleted after installation is complete.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates a related art portable computer;

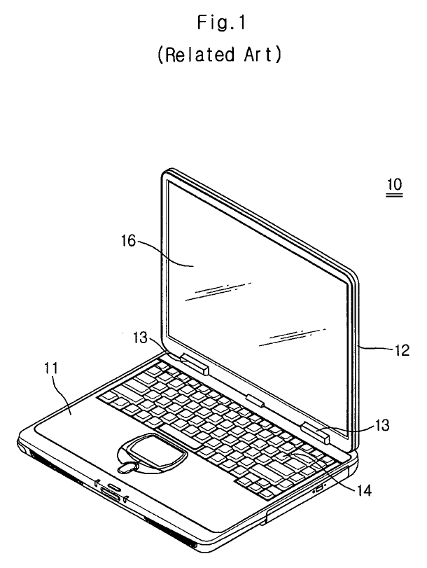

FIG. 2 illustrates a related art method for installing an Operating/System (O/S) and system software in a portable computer;

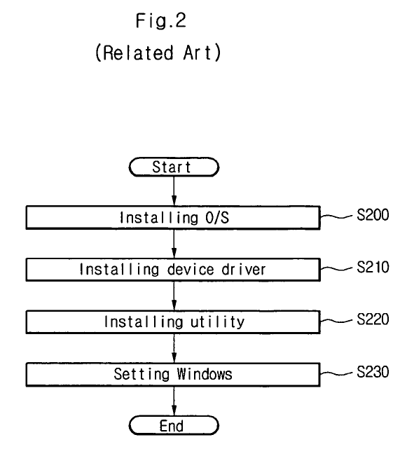

FIG. 3 is a diagram that illustrates a construction of a main body of an embodiment of a portable computer according to the present invention;

FIGS. 4 and 5 are diagrams that illustrate embodiments of software installation methods of a portable computer according to the present invention;

FIG. 6 is a flowchart illustrating another embodiment of a software installation method of a portable computer according to the present invention;

FIG. 7 is a flowchart illustrating yet another embodiment of a software installation method of a portable computer according to the present invention;

FIG. 8 illustrates an exemplary installation script file according to the present invention; and

FIG. 9 is a flowchart illustrating an embodiment of a software installation method for installing a device driver and a utility with reference to an installation script file depending on retrieved Operating/System (O/S) and device.

### DETAILED DESCRIPTION OF PREFERRED EMBODIMENTS

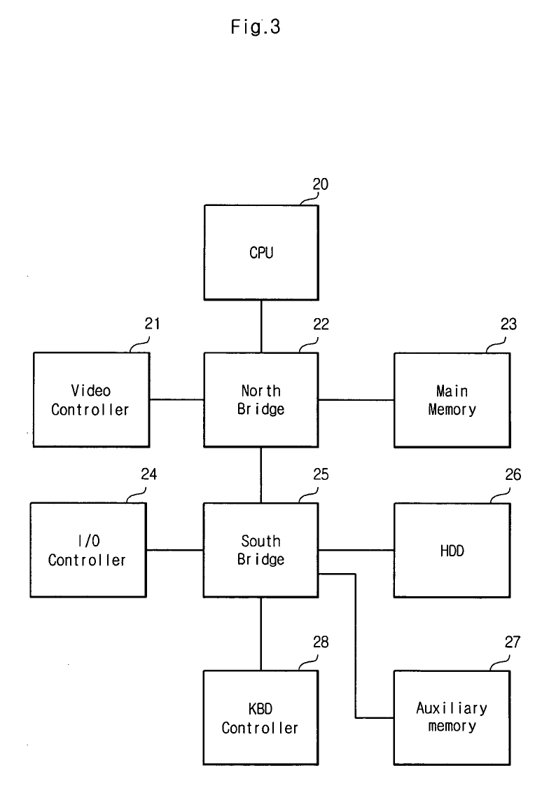

FIG. 3 is a diagram that illustrates an embodiment of a portable computer according to the present invention. As shown in FIG. 3, the portable computer has a main body that can include a Central Processing Unit (CPU) 20, a video controller 21, a north bridge 22, a main memory 23, an Input/Output (I/O) controller 24, a south bridge 25, a hard disk drive (HDD) 26, an auxiliary memory 27, and a keyboard (KBD) controller 28.

As shown in FIG. 3, parts of the main body are similar with the main body of a related-art portable computer. Accordingly, their detailed descriptions will be omitted here.

In embodiments of the portable computer, installation software for installing common system software and selection system software in a system can be stored in the hard disk drive 26. The installation software can be copied and stored from a server together with a pre-load image.

Accordingly, the installation software, the common system software, and the selection system software can be stored in the hard disk drive 26. However, embodiments of the invention are not intended to be so limited. Alternatively, for example, the installation software can be stored in an external storage unit, not in the hard disk drive 26, and can be activated in wire or wireless communication through a network.

The installation software programmed to install the common system software and the selection system software, can install the common system software and the selection system software in association with an installation script file.

The common system software can be essential system software. The common system software stored in the hard disk drive 26 are all preferably installed in the portable computer.

The selection system software can be selective system software. Only a part of the selection system software stored in the hard disk drive 26 is preferably installed in the portable computer.

For example, in case where the common system software A, B and C are stored in the hard disk drive 26, they can all be installed in the portable computer. On the contrary, in case where the selection system software D, E, F, G and H are stored in the hard disk drive 26, the selection system software can be partially installed in the portable computer such as installing D and F, or D, E and H.

In a related art, common system software and selection system software are installed as one pre-load image. Thus, there is an inconvenience in that a great number of the pre-load images should be developed and installed in the portable computer since the selection system software is varied depending on a language and a version of an Operating/System (O/S), and a kind of a device.

In other words, in the related art, the system software copied from a server and stored as the pre-load images are all installed in the portable computer. In contrast, in embodiments of the invention, only the part of the system software stored as the pre-load image is preferably installed in the portable computer. In embodiments of the invention, uninstalled software can be deleted.

In one embodiment, the essentially installed common system software and the selectively installed selection system software can be manufactured as one pre-load image so that the system software can be installed adaptively to various systems.

As such, the installation software can install the system software, and can set the O/S with reference to the installation script file. The installation script file can describe a method for selecting and installing the system software in various systems, and a method for setting the O/S in various systems.

In embodiments of the invention, the installation software can select and install the part of the stored system software, using the installation script file, the language and the version of the O/S retrieved in a plug-and-play manner, and information on the device.

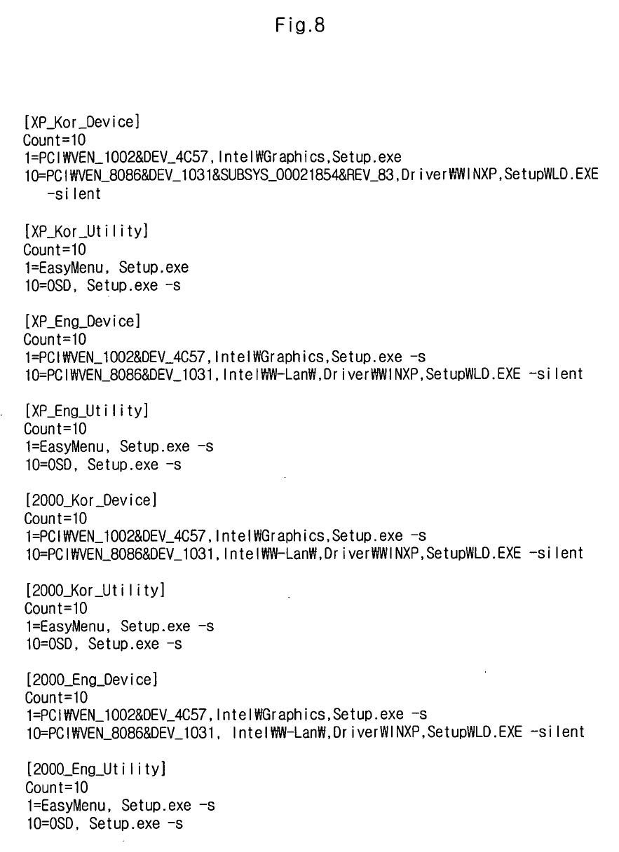

An example of the installation script file is illustrated in FIG. 8. As shown in FIG. 8, “[XP_Kor_Device]” can denote a kind of the retrieved O/S. For example, when the retrieved O/S is Korean XP, an installation operation of a device driver corresponding to “[XP_Kor_Device]” can be performed.

“Count=10” can denote the number of the devices that should be installed. For example, when the system has ten devices, ten device drivers should be installed and therefore, “count=10” can be expressed.

“1=PCI\VEN_{—}1002&DEV_{—}4C57,Intel\Graphics,Setup.exe” can denote that the first one of ten device drivers is a driver of a Peripheral Component Interconnect (PCI) device, that a vendor Identification (ID) (e.g., a chipset manufacturer ID) is 1002, and that a device ID of a chipset is 4C57. An execution file name of the driver installed in the device can be defined as “Setup.exe” in a lower “Graphics” of an “Intel” directory.

Similarly, “10=PCI\VEN_{—}8086&DEV_{—}1031&SUBSYS_{—}00021854&REV_{—}83, Driver\WINXP,SetupWLD.EXE-silent” can denote that the tenth one of ten device drivers is the driver of the PCI device, that the vendor ID is 8086, that the device ID of the chipset is 1031, that a subsystem ID is 00021854, and that a revision is 83. The execution file name of the driver installed in the device can be defined as “SetupWLD” in a lower “WINXP” of a “Driver” directory. Here, “-silent” can denote a selective value.

As shown in FIG. 8, a utility can be also defined in the installation script file in the same manner. “[XP_Kor_Utility]” can denote the kind of the retrieved O/S. For example, when the retrieved O/S is Korean XP, an installation operation of the utility corresponding to “[XP_Kor_Utility]” can be performed.

“Count=_” can denote a prescribed number of the utilities that should be installed. For example, when ten utilities should be installed, “count=10” is expressed.

“1=EasyMenu, Setup.exe” can denote that “EasyMenu” is the first one of ten utilities. Further, an execution file path can be “Setup.exe”.

“10=OSD, Setup.exe-s” can denote that “OSD” is the tenth one of the ten utilities, and that the execution file path is “Setup.exe” of “Root”. Further “-s” can be an installation option value that denotes a file of a compressed format.

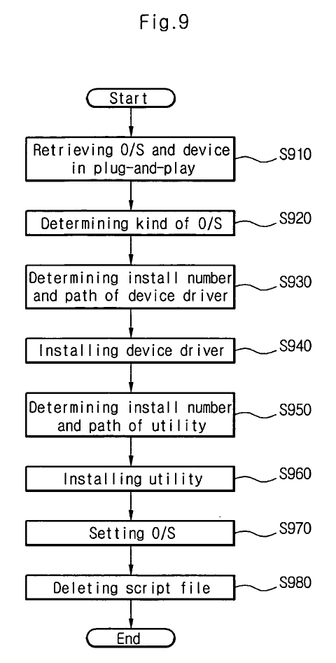

FIG. 9 is a flowchart illustrating an embodiment of a process of installing the device driver and the utility with reference to an installation script file depending on the retrieved O/S and device. As shown in FIG. 9, after a process starts, the O/S and the device can be retrieved (block 910). For example, the O/S and the device can be retrieved in the plug-and-play manner. After that, the kind of the O/S (e.g., the language and version of the O/S) can be determined (block 920).

Next, the installation number and the installation path of the device driver can be determined with reference to an installation script file (block 930). The device driver(s) can be installed (block 940).

After that, the installation number and the installation path of the utility can be determined with reference to the installation script file (block 950). Then, the utility/utilities can be installed (block 960).

In addition, the O/S can be set (block 970). Next, the installation script file can be deleted (block 980). From block S980, the process can be completed.

As described above, one embodiment of a method of the invention can have various installation script files defined for the device driver and the utility, and embodiments using the inventive installation software can check whether the system has any O/S and device after the system is booted. For example, the embodiment can check the system ID and the vendor ID in a BIOS program to confirm information on the PCI device and information such as a manufacturer of a video or audio device. Accordingly, the device driver and the utility can be retrieved from the installation script file, and appropriately retrieved device driver and utility can then be installed.

After the driver and the utility are completely installed, the installation script file is preferably deleted from the system.

In case where the driver and the utility are not completely installed, the installation script file is preferably not deleted from the system, and can be used when the driver or the utility is again installed. However, after the driver and the utility are completely installed, the installation script file is preferably deleted from the system.

One reason to delete the installation script file is to reduce the likelihood or prevent the installation software from resuming the installation operation using the installation script file when the system is rebooted. For example, when the installation script file exists without deletion, the installation software can check the device in the system and install the driver and the utility suitable to the device, and therefore it is desirable to delete the installation script file.

Thus, in one embodiment, the installation software can compare the installation script file with information of the retrieved O/S and device, and selectively install necessary software. For example, the installation software can compare the installation script file with ID information of the retrieved O/S and device, install the device driver and the utility, and then set the O/S such as Windows. For example, an installation script file such as <LGEnum.ini> exemplified below can be used.

An installation script file for recording the ID information of the retrieved O/S and device is exemplified below.

<LGEnum.ini>
[Enumeration]
Count=159
1=ROOT\ACPI_HAL\0000
2=ACPI_HAL\PNP0C08\0
.......
158=SCSI/CDROM&VEN_GENERIC&PROD_DVD-

ROM&REV_1.0/2&12B1DE20&0&010

159=SCSI/CDROM&VEN_GENERIC&PROD_DVD-

ROM&REV_1.0/2&12B1DE20&0&020

The installation script file (LGEnum.ini) can denote information values for enabling the installation software to install and set the common system software and the selection system software to the O/S.

“Count=159” can denote that the setting information value is 159 in number. Further, “1” of “1=ROOT\ACPI_HAL\0000” can denote the first setting information value, and “ROOT\ACPI_HAL\0000” can denote the installation path.

The common system software and the selection system software can all be installed during a manufacture process of the portable computer, which can then be provided to a consumer. However, the present invention is not intended to be so limited.

Alternatively, the common system software can be installed during the manufacture process of the portable computer, and the selection system software can be automatically installed after the portable computer is provided to the consumer.

The installed common system software and selection system software can be deleted from the hard disk drive 26, and the partial uninstallation selection system software can be also deleted from the hard disk drive 26.

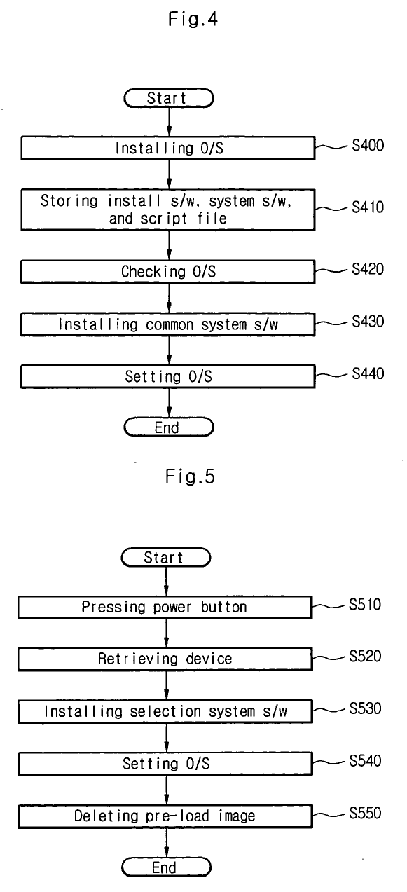

FIGS. 4 and 5 illustrate embodiments of software installation methods of the portable computer according to the invention. As shown in FIGS. 4 and 5, a system software installation method of the portable computer will now be described.

For reference, embodiments of the software installation methods of FIGS. 4 and 5 can be performed according to the selection, in a continuous installation manner or in a time or place-dependent installation manner.

As shown in FIG. 4, first, the O/S can be installed (block 400). After that, the installation software, the system software and the installation script file, which are preferably manufactured in a pre-load image format, can be stored (block 410).

The installation software can be stored in a hidden region of the hard disk drive. However, the invention is not intended to be so limited. In this case, the installation software can be stored before the installation of the O/S.

The pre-load image can be copied from the server and stored in the hard disk drive of the portable computer. In one embodiment, for ease of description, the system software can be distinguished into the common system software and the selection system software.

However, one key aspect of embodiments of the invention is that the system software manufactured in the pre-load image format and stored in the hard disk drive are not all installed, and only the part of the system software is adaptively installed in the system of the portable computer. Information on the setting of the O/S, or information on an installation sequence of the device driver or the utility that is included in the common system software and the selection system software, can be stored in the installation script file.

Next, the installation software can check the O/S, and install the common system software with reference to the installation script file (block 420).

After that, the installation software can install the common system software with reference to the installation script file (block 430).

Installing the common system software can include steps of installing a common driver and installing a common utility. The common utility can be exemplified as a Norton anti-virus program and a Windows media player.

Next, the installation software can set the O/S such as Windows (block 440). When the installation software sets the O/S, it preferably sets only a commonly used part of the O/S depending on the language and the version of the O/S and kinds of video and audio cards. The commonly used part of the O/S can be set to a predetermined desired or best configuration. For example, Window Power Policy can be set. Further, the installation software program can set a Window Registry or the like.

As shown in FIG. 4, the system software, which is commonly used in various systems, among the stored pre-load images can be installed and, the O/S can be set.

The system software installation process of FIG. 5 will now be described. As shown in FIG. 5, if a power button is pressed in the portable computer, the installation software can enable the system to be in a compulsory mode (e.g., TopMostWindows) (block 510), and retrieve the device (block 520).

In case where a user performs the installation process of FIG. 5, user information can be additionally inputted after the power button is pressed and before the compulsory mode is enabled. According to a set operation, the system software installation process can be also performed on the basis of user's selection, not in the compulsory mode.

The selection system software can be installed with reference to the installation script file depending on the retrieved device (block 530). Installing the selection system software can include the steps of installing a selection driver and installing a selection utility.

After that, the O/S can be set based on the installed system software (block 540). Through the installation processes described above, the pre-load image can be completely installed.

The uninstallation system software of the pre-load image and the installation script file can be all deleted. Alternatively, only the installation script file can be selectively deleted, or the pre-load image can all be deleted or not. In consideration of a storage space of the hard disk drive, unnecessary system software can be deleted after the installation of the pre-load image.

Preferably, only in case where the installation script file is stored, the system software can be installed automatically. In case where the system software needs to be installed again after the installation script file is deleted, the installation script file can be stored in the hard disk drive using a separate recording medium such as an optical recording medium.

The installation process of FIG. 5 can be performed after the portable computer is provided to the user. Accordingly, the manufacturer of the portable computer can greatly reduce a time taken to install the pre-load image.

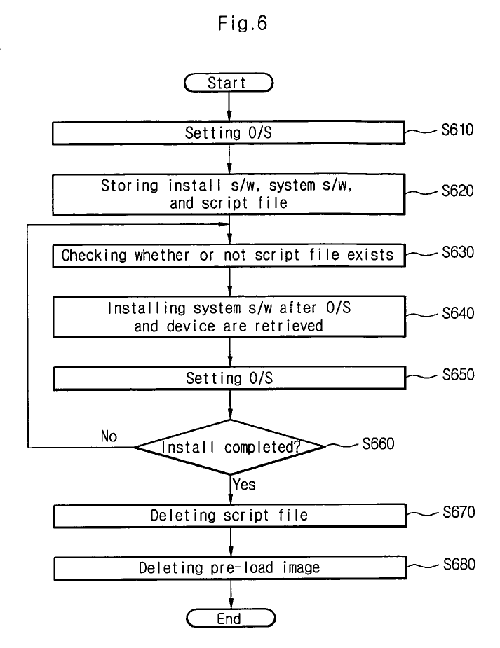

FIG. 6 is a flowchart illustrating another embodiment of a process of the software installation method of the portable computer according to the present invention. As shown in FIG. 6, the O/S can be installed in the portable computer (block 610). After that, the installation software, the system software provided in the pre-load image format, and the installation script file, can be stored in the hard disk drive (block 620).

The installation software can be stored in the hidden region of the hard disk drive before the installation of the O/S, and can be stored in the external storage unit and enabled in the wire or wireless network communication. The installation software can check whether or not the installation script file exists (block 630).

Next, on the basis of the retrieval result of the installed O/S and device, the system software can be installed with reference to the installation script file (block 640). After that, the O/S can be set based on the installed system software (block 650).

In a case where the installation is stopped by an internal or external cause, the installation can be continuously performed when the system is rebooted. For example, from block S660, a process can jump to block S630 or be repeated.

In a case where the installation is completed (block 660), the script file can be deleted (block 670), and the pre-load image can be also deleted (block 680). Further, the pre-load image can be all or partially deleted. From block S680, a process can be completed.

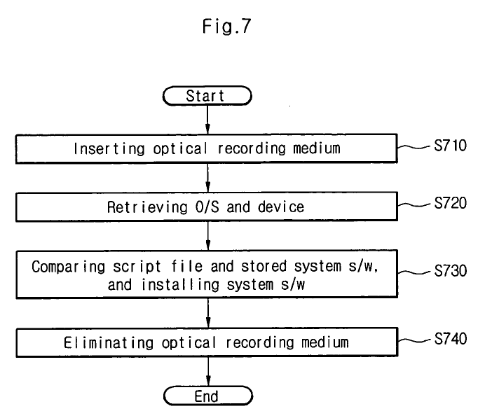

FIG. 7 illustrates an embodiment of a process of reinstalling the system software. The reinstalling process of FIG. 7 can be performed when the installed system software is deleted or is erroneously operated.

The optical recording medium for recording the installation script file can be inserted into an optical recording medium drive (block 710).

After that, the O/S and the device can be retrieved (block 720), and the installation script file and the stored system software are preferably compared with each other to reinstall the system software (block 730). The system software can be stored in the hard disk drive, or can be recorded on the optical recording medium together with the installation script file. However, the invention is not intended to be so limited.

If the system software is completely reinstalled, the optical recording medium can be eliminated (block 740). From block S740 the process can be completed.

As described above, in case where the installation script file is recorded on the optical recording medium, the optical recording medium can be inserted into the optical recording medium drive and then, the installation script file is preferably stored in the hard disk drive, so that the installation script file can be deleted from the hard disk drive when the system software is completely installed. Or, in case where the installation script file is recorded on the optical recording medium, the system software can be installed and then, the optical recording medium can be eliminated, so that a similar effect can be obtained as a case where the installation script file is deleted.

Through the above embodiments, the system software of the portable computer can be installed adaptively to the O/S and the device.

As described above, the re-installation of system software was described with general reference to an optical recording medium. However, the invention is not intended to be so limited. For example, an installation process can be performed or activated using wire or wireless communication with a network.

As described with various embodiments, an installation script file can exist for a plurality of different models (e.g., portable computer). However, the invention is not intended to be so limited. For example, an installation script file can exist for a plurality of different users.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments. Furthermore, for ease of understanding, certain method procedures may have been delineated as separate procedures; however, these separately delineated procedures should not be construed as necessarily order dependent in their performance. That is, some procedures may be able to be performed in an alternative ordering, simultaneously, etc.

As described above, embodiments of a portable computer and installation methods thereof have various advantages. For example, embodiments of a pre-load image installation method and apparatus have an advantage in that the development of the pre-load image can be easily or efficiently performed, for example, at a lower cost or less time. Further embodiments of pre-load image installation methods and apparatus have an advantage in that a manufacture cost of the pre-load image or an expense of the server for loading the manufactured pre-load image can be reduced or minimized.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A computer system, comprising:
a storage unit configured to store a plurality of system software, which can be installed depending on an installation script, wherein the installation script is deleted after installation is complete; and
a controller configured to selectively install system software that is required for the system, among the stored plurality of system software according to the installation script.

2. The system of claim 1, wherein the installation script for recording the system software is stored in the storage unit, and wherein the installation script stores the plurality of system software that is installed according to at least one of a plurality of different devices or Operating Systems (O/S) determined to be in the system.

3. The system of claim 2, wherein the controller is configured to compare the O/S or a device installed in the system with an installation script file, and selectively install the system software, which is required for the system, among the stored plurality of system software.

4. The system of claim 2, wherein the controller is configured to delete the installation script from the storage unit after the system software required for the system is completely installed.

5. The system of claim 4, wherein after the controller deletes the installation script, the installation script is stored using a separate storage medium, in the storage unit, and wherein the controller re-installs the system software only in case where the installation script is stored in the storage unit.

6. The system of claim 1, wherein the stored plurality of system software are selectively installed in a specific mode, and wherein the specific mode is selected in a compulsory manner or in a user selection manner.

7. The system of claim 1, wherein when the system software required for the system is not completely installed, the controller is configured to continue to install the system software when the system is rebooted.

8. The system of claim 1, wherein the system software is stored as a pre-load image, and wherein after the system software required for the system is completely installed, the controlling unit deletes all or a part of the stored plurality of system software from the storage unit.

9. A system software installation method comprising:
identifying a configuration of a computer system;
comparing the identified configuration with at least one installation script file corresponding to system software;
selectively installing a plurality of system software stored in a storage unit responsive to the comparison; and
deleting said at least one installation script file.

10. The method of claim 9, wherein the plurality of system software are stored as pre-load images.

11. The method of claim 9, wherein when the selectively installing is not completed, said at least one installation script file is not deleted.

12. The method of claim 11, wherein when the selectively installing is not completed, the selectively installing is subsequently continued at point corresponding to a previous installation point.

13. The method of claim 9, wherein installation software can be stored in a hidden region of a hard disk drive before the installation of an Operating System (O/S), or stored in an external storage unit and accessed using wire or wireless network communications.

14. The method of claim 9, wherein the installation script includes setting information, and wherein the setting information is related to selecting one of a predetermined set of conditions of the system software chosen by a preset priority.

15. The method of claim 14, wherein the setting information is deleted after installation is completed.

16. The method of claim 9, wherein the configuration includes an installed O/S (Operating/System) or device.

17. The method of claim 16, wherein the configuration includes identification information of the O/S and the device stored in the computer system, and wherein the configuration is recorded in a predetermined file and compared with the installation script file.

18. The method of claim 9, wherein the installation script file includes at least an OS installation script file, a utility installation script file or a device installation script file.

19. A software installation method of a portable computer, the method comprising:
inserting a storage medium for recording an installation script file;
retrieving an O/S (Operating/System) or a device stored in a computer system;
comparing the installation script file with information of the retrieved O/S or device; and
selectively installing system software depending on the comparison result, wherein the installation script file is removed after the installation of the system software.

20. The method of claim 19, wherein the storage medium is an optical recording medium, wherein the system software is stored in the computer system or the system software is stored in the optical recording medium.

21. The method of claim 19, further comprising storing the recorded installation script file in the computer system, wherein the stored installation script file is deleted after the installation of the system software.

22. The method of claim 19, wherein the information of the retrieved O/S and device is identification information of the O/S and device stored in the computer system, wherein the information of the retrieved O/S and device is recorded in a predetermined file and compared with the installation script file.

23. A computer system, comprising:
means for installing system software according to an installation script; and
means for storing a plurality of system software that can be installed depending on the installation script, wherein the installation script is deleted after installation is complete.
